(19) United States
(12) Patent Application Publication
(10) Pub. No.: US 2018/0009650 A1
(43) Pub. Date: Jan. 11, 2018

(54) FUEL MANAGEMENT METHOD FOR STATIONARY TRUCK USE

(71) Applicant: Air Liquide Large Industries U.S. LP, Houston, TX (US)

(72) Inventor: Jeffrey K. HARRINGTON, Pearland, TX (US)

(21) Appl. No.: 15/206,406

(22) Filed: Jul. 11, 2016

(51) Int. Cl. B67D 7/04; B67D 7/62; B67D 7/78; F17C 13/00; B67D 7/22; F17C 9/00; F17C 13/02

(52) U.S. Cl. CPC B67D 7/0401; F17C 9/00; B67D 7/62; F17C 13/02; F17C 13/004; B67D 7/221; B67D 7/78; B67D 2007/0444; F17C 2221/014

(57) ABSTRACT

A fuel management method for long term stationary truck use is provided. This method includes a truck with at least a first saddle tank or a second saddle tank integral to the truck. Each saddle tank has a fuel level sensor to measure the fuel level. A fuel trailer provides supplemental fuel, and a fuel pump downstream of the fuel trailer and upstream of the truck pressurizes the fuel from the fuel trailer. The method includes supplying fuel to local users from saddle tanks, activating the fuel pump when the fuel level of both the saddle tanks is less than a first predetermined threshold, thereby transferring fuel from the fuel trailer to the first saddle tank and the second saddle tank, deactivating the fuel pump when the fuel level of either the saddle tanks is greater than a second predetermined threshold.

### BACKGROUND

High purity nitrogen is normally obtained by cryogenic means. For small consumptions, the construction of a self-contained known production unit represents a prohibitive investment, in the case of automated installations, and a more limited investment but with high labor expenses in the opposite case which always represents a high cost for the nitrogen produced.

A more economical solution consists in utilizing a container for liquid nitrogen with large capacity, for example many tens of thousands of liters, from which liquid nitrogen is withdrawn and vaporized. As this is often an around the clock field operation, it is very demanding on the operator, who often must function as a repair man and field engineer as well. Typically these operations may last for days or weeks. Fuel availability and utilization for these trucks and the ancillary fuel using equipment on board is an issue that needs to be addressed.

### SUMMARY

In one embodiment of the present invention, a fuel management method for long term stationary truck use is provided. This method includes a truck with at least a first saddle tank or a second saddle tank integral to the truck. Each saddle tank has a fuel level sensor to measure the fuel level. A fuel trailer provides supplemental fuel, and a fuel pump downstream of the fuel trailer and upstream of the truck pressurizes the fuel from the fuel trailer. The method includes supplying fuel to local users from the first saddle tank or the second saddle tank, activating the fuel pump when the fuel level of both the first saddle tank and the second saddle tank is less than a first predetermined threshold, thereby transferring fuel from the fuel trailer to the first saddle tank and the second saddle tank, deactivating the fuel pump when the fuel level of either the first saddle tank or the second saddle tank is greater than a second predetermined threshold. The first predetermined threshold may be 50% of the tank capacity. The second predetermined threshold may be 70% of the tank capacity. The fuel pump may be pneumatic. The fuel pump may be a pneumatic diaphragm pump.

### BRIEF DESCRIPTION OF THE FIGURES

FIG. 1 the basic overall scheme, in accordance with one embodiment of the present invention.

FIG. 2 illustrates the triplex pump outlet pressure and/or flow rate control scheme, in accordance with one embodiment of the present invention.

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

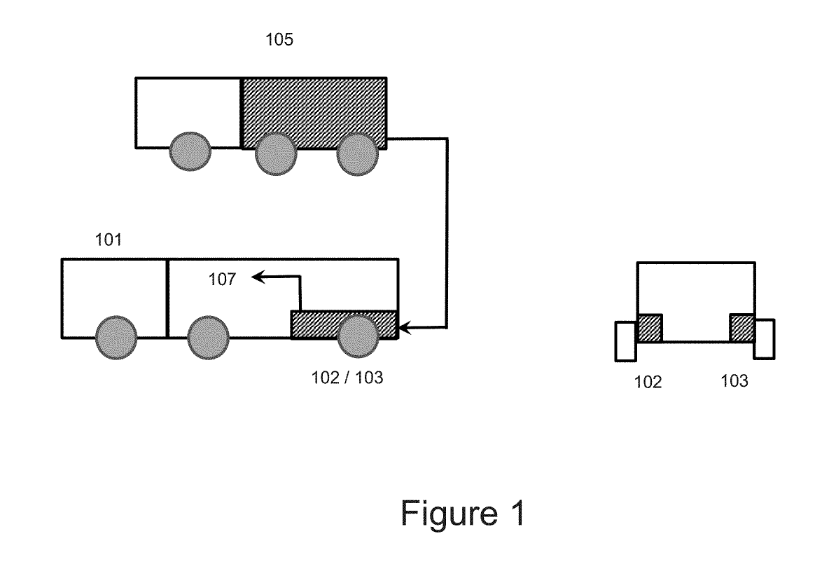

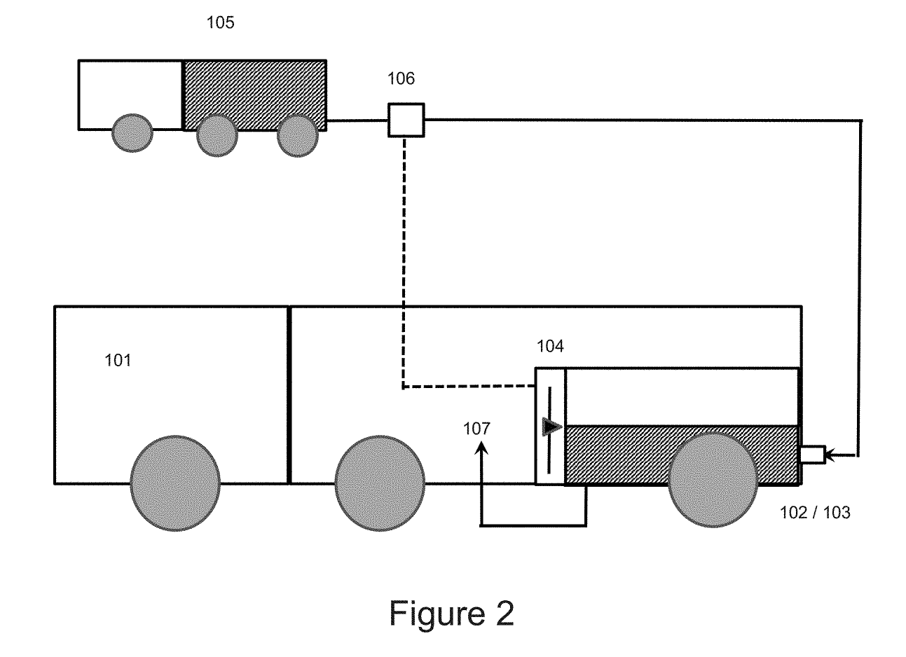

As illustrated in FIGS. 1 and 2, in one embodiment of the present invention, a fuel management method for long term stationary truck use is provided. While this fuel management method may be used for trucks of any size, heavy duty trucks, in Class 7 and Class 8, are anticipated to achieve the maximum benefit.

As used herein, a Class 7 truck will have a gross vehicle weight rating (GVWR) of between 26,001 and 33,000 lb. As used herein, a Class 8 truck will have a GVWR that exceeds 33,000 lb. As term “tractor-trailer”, “semi”, or 18-wheeler, refers to a Class 7 or Class 8 truck.

The truck 101 will have at least a first saddle tank 102 and a second saddle tank 103. As used herein, the term “saddle tanks”, also known as “side mounted tanks”, refer to the use of two, external fuel tanks, one on each side of the truck. Typically, a switch is mounted inside the cab that allows the driver to select with tank provides fuel. While the preferred embodiment of the present invention requires two saddle tanks, the skilled artisan will recognize that the same method is entirely applicable to trucks utilizing three or more tanks.

Each saddle tank 102,103 has a fuel level sensor 104 to measure the fuel level in that tank. There will be an auxiliary fuel trailer 105 nearby to provide additional, or supplemental fuel, to the stationary truck 101. The method includes a fuel pump 106 downstream of the fuel trailer 105 and upstream of the truck 101 pressurizes the fuel from the fuel trailer 105. The fuel pump 106 may be a 20 gpm pneumatic diaphragm pump. If the pump 106 is pneumatic, air to the pump may be provided via a gladhand connection on the pump 106 (providing air from the engine's compressor).

The two saddle tanks 102/103 provide fuel to local users 107 (not shown) as needed. These local users may include, but are not limited to, the truck engine itself, any local fluid booster pumps, high pressure pumps, reciprocating triplex pumps, vaporizers, heaters, etc.

When the fuel level 104 of both the first saddle tank 102 and the second saddle tank 103 drops below a first predetermined threshold, the pump 106 is activated. This allows fuel to be pumped from the auxiliary fuel trailer 105 into the saddle tanks 102/103. Once the fuel level 104 of either of the saddle tanks 102/103 reaches a second predetermined threshold, the pump 106 is deactivated.

The first predetermined threshold level will depend on factors unique to each operation. Such factors might include the number of devices 107 which are taking fuel from the saddle tanks 102/103, the rate of fuel usage, any intermittent nature of the fuel usage, the availability of additional fuel trailers as needed, etc. This fuel usage is variable, but may be as high as high as 2 gallons per minute. In one embodiment of the current invention, the first predetermined threshold may be 50% of the tank capacity. In another embodiment of the current invention, the first predetermined threshold may be 25% of the tank capacity.

Likewise, the second predetermined threshold level will depend on the above factors, or possibly alternative factors. In one embodiment of the present invention, the second predetermined threshold may be 70% of the tank capacity. In another embodiment of the present invention, the second predetermined threshold may be 80% of the tank capacity.

In one example of the present invention the tractor may comprise a chassis with a sleeper cab, and a triple rear axle (not shown). The truck engine may be a 600 HP Detroit Diesel (not shown). The system may be controlled by a programmable logic controller (not shown), such as an Allen Bradley PLC with an associated touch screen which reads process variables and reacts accordingly.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A fuel management method for long term stationary (Class 8) truck use, wherein:
the truck comprises at least a first saddle tank or a second saddle tank integral to the truck,
each saddle tank comprises a fuel level sensor to measure the fuel level,
a fuel trailer provides supplemental fuel, and
a fuel pump downstream of the fuel trailer and upstream of the truck pressurizes the fuel from the fuel trailer,
the method comprising:
supplying fuel to local users from the first saddle tank or the second saddle tank,
activating the fuel pump when the fuel level of both the first saddle tank and the second saddle tank is less than a first predetermined threshold, thereby transferring fuel from the fuel trailer to the first saddle tank and the second saddle tank,
deactivating the fuel pump when the fuel level of either the first saddle tank or the second saddle tank is greater than a second predetermined threshold.

2. The fuel management method of claim 1, wherein the first predetermined threshold is 50% of the tank capacity.

3. The fuel management method of claim 1, wherein the second predetermined threshold is 70% of the tank capacity.

4. The fuel management method of claim 1, wherein the fuel pump is pneumatic.

5. The fuel management method of claim 1, wherein the fuel pump is a pneumatic diaphragm pump.
